(19) United States
(12) Patent Application Publication
(10) Pub. No.: US 2025/0117418 A1
(43) Pub. Date: Apr. 10, 2025

(54) LAYERED DATABASE QUERIES FOR CONTEXT INJECTION

(71) Applicant: Insight Direct USA, Inc., Chandler, AZ (US)

(72) Inventors: David McCurdy, Centennial, CO (US); Jason Rader, Jacksonville, FL (US)

(21) Appl. No.: 18/911,815

(22) Filed: Oct. 10, 2024

Related U.S. Application Data
(60) Provisional application No. 63/543,457, filed on Oct. 10, 2023.

(51) Int. Cl. G06F 16/33

(52) U.S. Cl. CPC G06F 16/3344; G06F 16/3347

(57) ABSTRACT

A method includes receiving a natural-language prompt from a user and a user identifier corresponding to the user, querying a first database with the user identifier to retrieve first information, generating a vector embedding representative of the first information and the natural-language prompt, and querying a second database using the vector embedding to retrieve second information. The second database is a vector database comprising a plurality of vectors, each vector of the plurality of vectors representative of a text segment of a plurality of text segments, and the second information comprises at least one text segment of the plurality of text segment. The method further includes generating, by a language model executed by the processor, a natural-language response text responsive to the user query based on the natural-language prompt, the first information, and the second information.

### CROSS-REFERENCE TO RELATED APPLICATION

This application is a nonprovisional application claiming the benefit of U.S. provisional Ser. No. 63/543,457, filed on Oct. 10, 2023, entitled “LAYERED DATABASE QUERIES FOR CONTEXT INJECTION” by D. McCurdy and J. Rader.

### FIELD OF THE INVENTION

The present disclosure relates to context injection for generative language models and, more particularly, systems and methods for layered database queries for context retrieval.

### BACKGROUND

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat.

Human-generated prompts can be augmented with additional information to provide context to the language model and improve the accuracy and/or relevance of natural-language generated by the model in response to a prompt.

### SUMMARY

An example of a method includes receiving a natural-language prompt from a user and a user identifier corresponding to the user, querying a first database with the user identifier to retrieve first information, generating a vector embedding representative of the first information and the natural-language prompt, and querying a second database using the vector embedding to retrieve second information. The second database is a vector database comprising a plurality of vectors, each vector of the plurality of vectors representative of a text segment of a plurality of text segments, and the second information comprises at least one text segment of the plurality of text segment. The method further includes generating, by a language model executed by a processor of a network-connected device, a natural-language response text responsive to the user query based on the natural-language prompt, the first information, and the second information.

An example of a system include a first database configured to store first user-specific information, a second database configured to store a plurality of vector embeddings representative of a plurality of natural-language text segments, and a network-connected device in electronic communication with the first database and with the second database. Each vector embedding of the plurality of vector embeddings is representative of one natural-language text segment of the plurality of natural-language text segments. The network-connected device includes a processor and at least one memory encoded with instructions that, when executed, cause the processor to receive a natural-language prompt from a user and a user identifier corresponding to the user, query the first database with the user identifier to retrieve first information, generate a vector embedding representative of the first information and the natural-language prompt, query the second database using the vector embedding to retrieve second information, and generate, using a language model executed by the processor, a natural-language response text responsive to the user query based on the natural-language prompt, the first information, and the second information.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for providing context to user prompts for a language model using layered database queries.

FIG. 2 is a flow diagram of an example of a method of performing layered queries for context injection for natural-language text generation by language models.

FIG. 3 is a flow diagram of an example of a method creating database vectors based on a user's chat history.

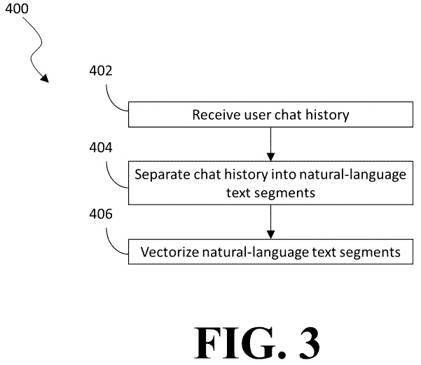

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for performing sequential, layered database queries for context injection approaches to reduce language model hallucinations and/or fabrications. As will be explained in more detail subsequently, the systems and methods disclosed herein use enable the injection of user-specific information into a user-supplied prompt for querying a vector database. The information retrieved from the vector database and the user-specific information can then be used to supplement the original user prompt prior to natural-language text generation by the language model. The systems and methods disclosed herein significantly improve the relevance of vector database queries to an individual user and, accordingly, can be used to reduce the quantity of text provided to a language model as context while providing similar or superior improvements to hallucination/fabrication reduction as systems and methods using significantly more text information as context for natural-language text generation. Advantageously, reducing the quantity of text used as input to a language model can provide concomitant reductions to processing power and time required to generate a natural-language output.

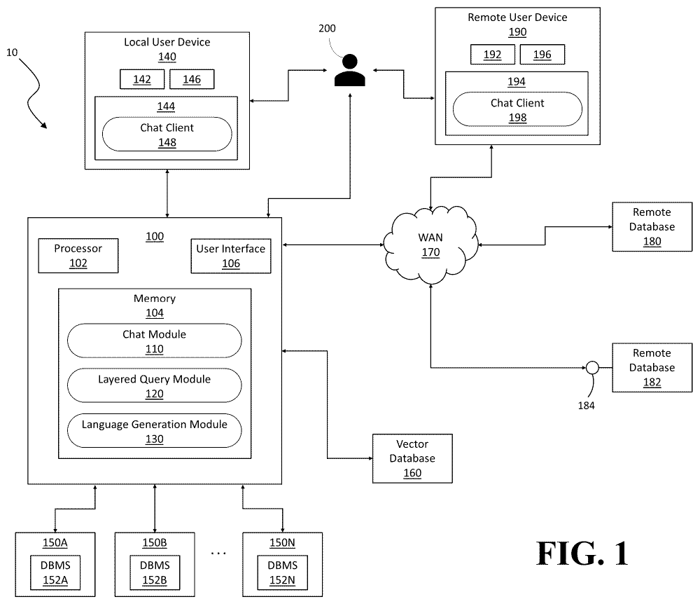

FIG. 1 is a schematic depiction of system 10, which is a system for providing context to user prompts for a language model using layered database queries. System 10 includes server 100, local user device 140, databases 150A-N, vector database 160, wide area network (WAN) 170, remote database 180, remote database 182, application programming interface (API) 184, and remote user device 190. Server 100 includes processor 102, memory 104, and user interface 106. Memory 104 stores chat module 110, layered query module 120, and language generation module 130. Local user device 140 includes processor 142, memory 144, and user interface 146. Remote user device 190 includes processor 192, memory 194, and user interface 196. Memory 144 and memory 194 store chat client 148 and chat client 198, respectively. Databases 150A-N organize data using database management systems (DBMSs) 152A-N, respectively. FIG. 1 also depicts user 200. As will be explained in more detail subsequently, system 10 uses a layered query approach to incorporate retrieve contextual information that can be used to augment user prompts provided to a language model, reducing fabrications (e.g., AI hallucinations) created by the language model and also increasing both the accuracy of responses generated by the language model as well as the value of those responses for users. The layered query approach detailed herein uses successive database queries to retrieve information from multiple databases. More specifically, the layered query approach detailed herein incorporates information retrieved from one or more initial queries of structured and/or semi-structured databases to augment subsequent queries made to one or more vector databases. All information retrieved (i.e., data retrieved from both structured/semi-structured and vector databases) can be incorporated into the initial user prompt to provide context to a language model that generates responses for natural-language chat applications.

Server 100 is a network-connected device that is connected to WAN 170 as well as local user device 140, databases 150A-N, and vector database 160. Server 100 also includes or more hardware elements, devices, etc. for facilitating electronic communication with WAN 170, databases 150A-N, local user device 140, a local network, and/or any other suitable device via one or more wired and/or wireless connections. Although server 100 is generally referred to herein as a server, server 100 can be any suitable network-connectable computing device for performing the functions of server 100 detailed herein.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on server 100 (e.g., by a computer-implemented machine-learning model or a data processing module) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator, such as user 200, to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

As will be described in more detail subsequently, server 100 generates natural-language text responses based on user-provided natural-language prompts. In at least some examples, server 100 can generate natural-language text responses for a chat service, such that the user-provided prompts and natural-language text responses generated by server 100 mimic a conversation between two humans. Users can access chat functionality of server 100 by directly accessing server 100 (e.g., by user interface 106) and/or by accessing the functionality of server 100 through another device, such as local user device 140 and/or remote user device 190.

Local user device 140 is a user-accessible electronic device that is directly connected to server 100 and/or is connected to server 100 via a local network. Local user device 140 includes processor 142, memory 144, and user interface 146, which are substantially similar to processor 102, memory 104, and user interface 106, respectively, and the discussion herein of processor 102, memory 104, and user interface 106 is applicable to processor 142, memory 144, and user interface 146, respectively. Local user device 140 can be, for example, a personal computer or any other suitable electronic device for performing the functions of local user device 140 detailed herein. Memory 144 stores software elements of chat client 148, which will be discussed in more detail subsequently and particularly with respect to the function of chat module 110 of server 100.

Databases 150A-N are electronic databases that are directly connected to server 100 and/or are connected to server 100 via a local network. Each of databases 150A-N includes machine-readable data storage capable of retrievably housing stored data, such as database or application data. In some examples, one or more of databases 150A-N includes long-term non-volatile storage media, such as magnetic hard discs, optical discs, flash memories and other forms of solid-state memory, or forms of electrically programmable memories (EPROM) or electrically erasable and programmable (EEPROM) memories. Databases 150A-N organize data using DBMSs 152A-N, respectively, and each of databases 150A-N can include a processor, at least one memory, and a user interface that are substantially similar to processor 102, memory 104, and user interface 106 of server 100. In at least some examples, one or more of databases 150A-N are relational databases. Each of databases 150A-N a structured database (e.g., a table or relational database) or a semi-structured database (e.g., a hierarchical and/or nested database). Databases 150A-N store data describing users who access server 100 and the software modules thereof (e.g., user 200). Databases 150A-N can store, for example, descriptive user information, such as user purchase history, user device information, or another suitable type of information for describing a user. Databases 150A-N can be configured to be queryable using user identifiers, such as user credentials (e.g., credentials for accessing server 100 functionality, such as a username or password), account numbers, and/or other suitable user descriptors to retrieve stored user information.

DBMS 152A-N are database management systems. As used herein, a “database management system” refers to a system of organizing data stored on a data storage medium. In some examples, a database management system described herein is configured to run operations on data stored on the data storage medium. The operations can be requested by a user and/or by another application, program, and/or software. The database management system can be implemented as one or more computer programs stored on at least one memory device and executed by at least one processor to organize and/or perform operations on stored data.

Vector database 160 is an electronic database that stores vector information representative of natural-language text. The vectors stored in vector database 160 are embedded as vectors using an embedding model/algorithm that transforms natural-language text into vectors representative of the text. The vectors can represent the words of the natural-language text (e.g., word vectors) and/or any other suitable element of the text. The natural-language text represented by the vectors of vector database 160 can be, for example, chat logs collected by chat module 110 and/or chat clients 148, 198. The vectors of vector database 160 can represent any suitable length of text, such as sentences, paragraphs, etc. In at least some examples, the vectors of vector database 160 represent sentences within messages and/or entire messages sent through the chat program(s) of chat module 110. The vectors of vector database 160 can represent both user queries and responses generated by server 100. For example, chat module 110 and/or chat client 148, 198 can collect and/or store a chat history of all messages sent within a particular time period, including all prompts sent by a user in chat client 148, 198 as well as all responses generated by the programs of server 100 to those prompts. Server 100 and/or vector database 160 can separate the chat history into individual messages and/or sentences (i.e., in examples where a message includes more than one sentence), and store vector embeddings of those text segments in vector database 160. Additionally and/or alternatively, vector database 160 can store vector embeddings of pre-generated (e.g., by a human operator) text usable to provide context to the program(s) of language generation module 130. For example, vector database 160 can store vector embeddings of templates, forms, pre-generated response text, etc.

To query vector database 160, server 100 and/or vector database 160 can generate a vector embedding of query text and compare that vector to the vectors stored to vector database 160. The vector embedding of the query text is referred to herein as a “query vector” and the vectors of the database are referred to herein as “database vectors.” The query vector can be generated using the same embedding algorithm and/or have the same number of dimensions as the database vectors (i.e., the vectors of vector database 160). Vectors stored to vector database 160 having a similarity score above a particular threshold and/or having the highest overall similarity to the query vector can be returned in response to the query. Vector similarity can be assessed by cosine similarity, cartesian similarity, and/or any other suitable test for assessing vector similarity. The corresponding raw data (i.e., the raw text information) represented by the returned vectors can then be retrieved and provided to server 100.

WAN 170 is a wide-area network suitable for connecting servers (e.g. server 100) and other computing devices that are separated by greater geographic distances than the devices of a local network, such as a local network connecting server 100 to local user device 140 and/or databases 150A-N. WAN 170 includes network infrastructure for connecting devices separated by larger geographic distances. In at least some examples, WAN 170 is the Internet. Server 100 can communicate with remote database 180, remote database 182, and remote user device 190 via WAN 170.

Remote databases 180, 182 are remotely-located databases accessible by server 100 via WAN 170. Each of remote databases 180, 182 can be substantially similar to databases 150A-N and/or vector database 160. Remote database 180 is directly accessible (e.g., queryable) by server 100 and remote database 182 operates API 184. Server 100 can access data of database 180 by, for example, sending queries to remote database 180. Server 100 can access data of remote database 182 by sending API commands to API 184. API 184 can then query remote database 182 in response to API commands issued by server 100 and can provide data retrieved by remote database 182 in response to queries to server 100. API 184 can also perform additional database operations (i.e., operations other than retrieval) on the data of remote database 182) For explanatory clarity and simplicity, system 10 is shown as only including two remote databases 180, 182. However, system 10 can include any suitable number of remote, WAN-accessible databases. Further, for explanatory clarity and simplicity, the example of system 10 shown in FIG. 1 only depicts remote database 182 as including an API for accessing database 182. However, system 10 can include any number of remote databases that operate APIs for facilitating database access from server 100 and, in some examples, from other devices connected to WAN 170. API 184 can be any suitable API for performing database operations.

In some examples, databases 150A-N can be partitions of a single database and, in yet further examples, system 10 can include only one database 150A-N. In yet further examples, one or both of remote databases 180, 182 can be a structured or semi-structured database performing the same functions as a database 150A-N, and system 10 can lack or omit databases 150A-N. Further, in some examples, one or both of remote databases 180, 182 can at least partly operate as a vector database performing the same functions as vector database 160 and system 10 can lack a locally-hosted vector database 160. Additionally and/or alternatively to any of the foregoing examples, system 10 can lack or omit one or both of remote database 180 and remote database 182.

Remote user device 190 is a user-accessible electronic device that is connected to server 100 via WAN 170. Local user device 190 includes processor 142, memory 144, and user interface 146, which are substantially similar to processor 102, memory 104, and user interface 106, respectively, and the discussion herein of processor 102, memory 104, and user interface 106 is applicable to processor 192, memory 194, and user interface 196, respectively. Remote user device 190 can be, for example, a personal computer or any other suitable electronic device for performing the functions of remote user device 190 detailed herein. Memory 194 stores software elements of chat client 198, which will be discussed in more detail subsequently and particularly with respect to the function of chat module 110 of server 100.

Chat module 110 is a software element of server 100 and includes one or more programs for operating a chat application in conjunction with chat client 148, 198. The program(s) of chat module 110 receive user prompts from chat clients 148, 198 and provide those user prompts to layered query module 120 and language generation module 130. Chat module 110 is also able to provide responses generated by language generation module 130 to chat client 148, 198. Chat clients 148, 198 are different instances of a chat application instantiated on local user device 140 and remote user device 190. Chat module 110 is also configured to receive and/or request user credentials from chat clients 148, 198 and to limit access to the functionality of server 100 to users having valid user credentials. The user credentials can be one or more of a username, a password, or any other identifier suitable for identifying a particular user of the chat functionality of server 100.

Chat clients 148, 198 are software applications that are able to provide user prompts to server 100 and to receive responses from server 100. Chat clients 148, 198 can be, in some examples, web browsers for accessing a web application hosted by server 100 that uses the functionality of chat module 110. In other examples, chat clients 148, 198 can be specialized software applications for interacting with chat module 110 of server 100. A user prompt submitted to server 100 through a chat client 148, 198 is a natural-language text string including, for example, one or more user queries, one or more instructions, one or more discussion topics, etc. In some examples, chat clients 148, 198 can include some or all of the functionality of chat module 110 and server 100 can lack chat module 110, such that local user device 140, remote user device 190, etc. are able to perform the functions of chat module 110. Further, while chat clients 148, 198 are referred to herein generally as separate chat clients, chat clients 148, 198 can be different instances, installations, etc. of a single chat client.

Layered query module 120 is a software element of server 100 and includes one or more programs for performing layered queries of structured or semi-structured databases and vector databases. As will be explained in more detail subsequently, layered query module 120 is configured to retrieve user-specific information from a structured or semi-structured database (e.g., one of databases 150A-N) based on user identifier information. Layered query module 120 is further configured to retrieve text string information from a vector database (e.g., vector database 160) based on both a user query received by chat module 110 and the retrieved user-specific information. The sequential querying of structured/semi-structured databases and vector databases and the use of information retrieved from the structured/semi-structured database to formulate a query to a vector database is referred to herein as a “layered query” or a “layered database query.”

The program(s) of layered query module 120 can generate queries for databases 150A-N and vector database 160, and further can generate queries and communicate with remote database 180 and remote database 182. The program(s) of layered query module 120 can optionally be configured to generate API commands for API 184 in order to query remote database 182. Layered query module 120 is configured to generate database queries based on user identifier information and, further, based on user prompts supplied via a chat client 148, 198. The user identifier information can be, for example, credentials used to access server 100 functionality and/or another identifier retrieved based on user credential information. Layered query module 120 can optionally be configured with a vector embedding algorithm for generating query vectors for vector database 160 or another suitable vector database based on natural-language text information and information retrieved from a structured or semi-structured database.

Language generation module 130 is a software element of server 100 and includes one or more programs for generating natural-language outputs based on natural language user prompts as well as information retrieved by the program(s) of layered query module 120. Language generation module 130 can use one or more trained, computer-implemented machine-learning models to generate natural-language responses to user prompts. The one or more trained, computer-implemented machine-learning models can be, for example, one or more language models, such as one or more large language models. The one or more language models and/or large language models can be, for example, one or more trained transformer models configured to generate natural-language outputs based on natural-language inputs.

In operation, a user, such as user 200, provides a prompt to a user device running an instance of a chat client for chat module 110, such as chat client 148 of local user device 140 or chat client 198 of remote user device 190. The prompt is natural-language text and, in some examples, includes one or more requests. The chat client provides the user prompt to server 100. The chat client also provides a user identifier for the user. The user identifier can be, for example, access credentials for validating that the user is approved to access functionality of server 100, or any other suitable identifier for the user, such as the user's name, an account number for the user (e.g., a business account number), etc. In some instances, the user identifier can be provided within the natural language text of the prompt; in other instances, the user identifier can be provided by the user separately, or retrieved based on a source of the prompt, user permissions, or other contextual information.

The program(s) of layered query module 120 uses the user identifier received from the chat client to query a structured database or semi-structured database (e.g., one or more of databases 150A-N, one of remote databases 180, 182, etc.) to retrieve user-specific information for the user. The queried database stores information in a structure that is queryable with user identifiers and is able to return additional information describing the user based on the user identifier. The user-specific information can be, for example, one or more recent purchases made by the user, an account type and/or level held by the user, user financial information, etc. The program(s) of layered query module 120 can combine the retrieved information with the user's natural-language prompt to form an augmented prompt. The program(s) of layered query module 120 can create a vector embedding of the augmented prompt and/or the program(s) of layered query module 120 can provide the augmented prompt to vector database 160 and one or more program(s) of vector database can create a vector embedding of the augmented prompt. The vector embedding can then be used to query vector database and similar database vectors of vector database 160 can be identified in response to the query. Vector database 160 can retrieve the natural-language text represented by the identified vectors and provide that natural-language text to server 100.

In some examples, the database vectors of vector database 160 can include embedding dimensions that correspond to the types of data retrievable from the structured or semi-structured databases, such that vector retrieval by vector database 160 is able to use similarity in those vector embedding dimensions of the query vector and database vectors to narrow the search space of vector database 160, advantageously reducing the computational cost associated with searching vector database 160. Additionally and/or alternatively, the vectors of vector database 160 can represent user-specific information in embedding dimensions that are not specific to or exclusively representative of user-specific information. Advantageously, this can provide additional information to accurately identify user-relevant natural-language text information for context injection when searching vector database 160.

The program(s) of layered query module 120 provide the original user prompt, the information retrieved from the structured or semi-structured database, and the information retrieved from vector database 160 to language generation module 130. The computer-implemented machine-learning model(s) of language generation module 130 generate a natural-language response to the user prompt using the user prompt, the information retrieved from the structured or semi-structured database, and the information retrieved from vector database 160 to language generation module 130. Advantageously, the use of the retrieved information from the structured or semi-structured database and vector database 160 provides additional context to the trained, computer-implemented machine-learning model and improves the accuracy of the natural-language response generated thereby, reducing the occurrence of AI hallucinations or fabrications that can occur during natural-language text generation.

In some examples, the program(s) of layered query module 120 can query multiple structured and semi-structured databases using the user identifier and can use retrieved information from multiple databases to create the augmented prompt used to query vector database 160. Additionally and/or alternatively, the program(s) of layered query module 120 can query multiple structured or semi-structured databases with the user identifier and use only a subset of the retrieved information to query vector database 160. In these examples, the additional retrieved information can be provided to language generation module 130 as context for response generation. Further, in some examples, the information retrieved from the structured or semi-structured database (i.e., the information retrieved based on the user identifier) is used to query vector database 160 and only the information retrieved from vector database 160 and the original user prompt can be provided to language generation module 130, such that the initial retrieved information is not used to generate a natural-language response.

In some examples, vector database 160 can be partitioned such that different partitions of vector database 160 store vector embeddings of text specific to particular user identifiers (e.g., to particular users, to particular items purchasable by users, etc.). Layered query module 120 can use the user identifier(s) for a user to identify one or more relevant partitions of vector database and query those partitions with a query vector representative of the user prompt and/or both the user prompt and the user identifier(s).

The layered database query approach outlined herein has numerous advantages over conventional database retrieval approaches for context injection, such existing retrieval-augmented generation (RAG) methods. Layered query module 120 enables user-specific information to be used to query a vector database prior to natural-language text generation by language generation module 130. The user-specific vector database queries described herein increase the likelihood that text information retrieved from a vector database query is relevant to a particular user and, in turn, reduces the likelihood that irrelevant or extraneous information is retrieved. Advantageously, reducing the overall quantity of text provided to a language model (or other computer-implemented machine-learning model configured to generate natural-language) as context (e.g., via RAG or a RAG-like approach) can reduce the computational cost associated with generating response text and, accordingly, can reduce the overall time required to generate the response text. Further, the user-specific queries performed by layered query module 120 are able to create context-augmented prompts for language generation that reduce computational cost while provided similar or superior hallucination/fabrication reduction as existing context injection techniques that use conventional vector database retrieval. Reducing time required to generate response text can also advantageously reduce lag perceived by users between prompt submission (i.e., via chat clients 148, 198) and response receipt (i.e., of a natural-language response generated by language generation module 130).

Further, in examples where inputs to the language model are token-limited (i.e., where prompt or input text is limited to a particular size, or where increased computational costs associated with larger prompts increase corresponding fees), the layered queries layered query module 120 can significantly increase the accuracy of a response generated from a particular, fixed number of tokens.

Additionally, the layered query approach outlined herein can be used to reduce computational costs associated with vector database queries used for content injection. More specifically, the user-specific information retrieved from a structured or semi-structured database increases the likelihood that vectors retrieved from a vector database are representative of user-relevant information, allowing accurate database retrieval to be performed using query and database vectors having a relatively low or otherwise decreased number of vector dimensions. Advantageously, reducing the number of vector dimensions compared during a vector database query reduces computational cost associated with querying the vector database. Reducing the computational cost associated with querying the vector database further reduces the time required by server 100 to process and provide responses to user prompts, providing further improvements to the lag perceived by users between prompt submission and response receipt.

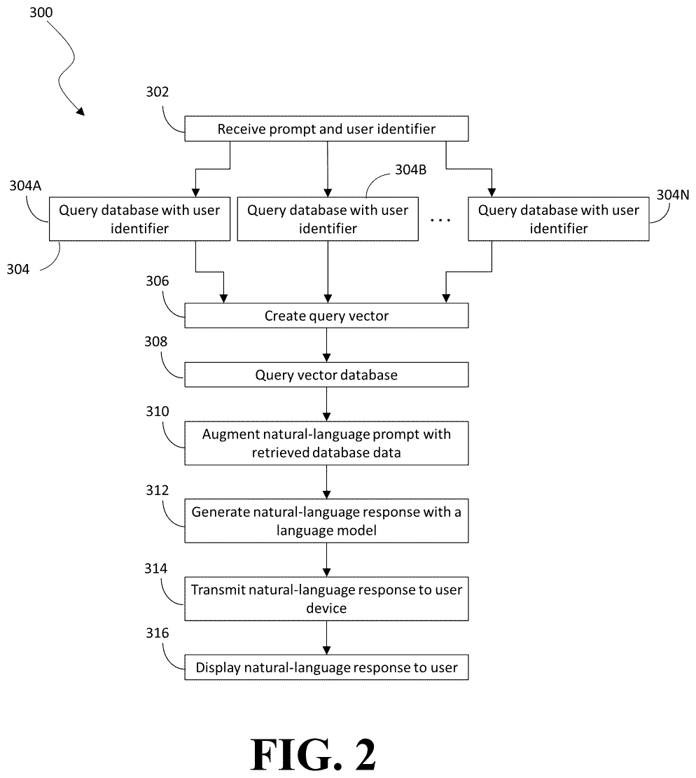

FIG. 2 is a flow diagram of method 300, which is a method of performing layered queries for AI context injection performable by system 10 (FIG. 1). Method 300 includes steps 302-316 of receiving a prompt and a user identifier (step 302), querying a database with the user identifier (steps 304A-N), creating a query vector (step 306), querying a vector database (step 308), augmenting a natural-language query with retrieved database data (step 310), generating a natural-language response with a language model (step 312), transmitting the natural-language response to a user device (step 314), and displaying the natural-language response to the user (step 316). Method 300 performable by server 100 of system 10 and is described herein with reference to system 10 (FIG. 1), but method 300 can be implemented in any suitable system to enable layered database query-based context injection. Advantageously, method 300 significantly computational costs associated with context injection (e.g., RAG), thereby also reducing time required to generate context-enhanced natural-language responses using a language model.

In step 302, server 100 receives a prompt and a user identifier from a user device, such as local use device 140 or remote user device 190. A user can enter a prompt into a chat client configured to interact with and use functionality of server 100 (e.g., chat client 148, chat client 198, etc.). The chat client can provide the prompt and an identifier for the user to server 100. The prompt is natural-language text (e.g., a text string) that includes a natural-language representation of one or more user queries, one or more instructions, one or more discussion topics, etc. The user identifier can be, for example, an account name, an access credential (e.g., a username), an account number, the user's personal name (e.g., a first and/or last name), etc. In some examples, a user can submit access credentials (e.g., a username, password, etc.) to the chat client and the chat client can verify that the user is approved to access server 100 functionality by validating the provided credentials with credentials stored to server 100. The chat client can store or retain an identifier for the user and can provide that identifier as the user identifier with prompts submitted by the user to server 100.

After step 302, method 300 proceeds to one or more of steps 304A-N. Steps 304A-N are collectively referred to herein as “steps 304” and steps 304A-N are individually referred to herein as a “step 304.” In each of steps 304, server 100 queries a structured or semi-structured database to retrieve user-specific information, such as identifying information for the user, one or more recent purchases made by the user, an account type and/or level held by the user, user financial information, etc. While FIG. 2 shows three steps 304 (i.e., steps 304A, 304B, 304N), method 300 can include any number steps 304. In some examples, method 300 can include only a single step 304, such that server 100 only queries a single database with the user identifier. The number of steps 304 included in method 300 can be selected according to the number of database queries desired to be performed.

In step 306, a query vector is created using the user prompt received in step 302 and database information retrieved in step(s) 304. Creation of a query vector can be performed by either server 100 or the vector database. Server 100 can create the query vector by creating a vector embedding representative of the user prompt and one or more information elements retrieved in step(s) 304. Some or all of the information retrieved in step 304 can be used to create the query vector in step 306. Server 100 can then query the vector database with the query vector. Additionally and/or alternatively, server 100 can provide the user prompt and at least some of the information retrieved in step(s) 304 to the vector database, and the vector database can create a vector embedding of the prompt and the provided database information.

In some examples, it may be advantageous to retrieve more information from databases in step(s) 304 than is provided in step 306. For example, if the information represented in the database vectors is not related to some of the information retrieved in step(s) 304, including that information in the query vector can decrease the relevancy of information returned from a vector database query using the query vector. However, in yet other examples, it can be advantageous to represent all information retrieved in step(s) 304 in the query vector. In all examples, the query vector is an embedding of the user prompt and at least some of the information retrieved in step(s) 304.

In step 308, server 100 queries the vector database with the query vector created in step 306. Querying the vector database in step 308 identifies one or more database vectors having a sufficient similarity to the query vector. The vector database can use any suitable similarity test and any suitable similarity threshold for identifying similar vectors. The similarity test can be, for example, a cosine similarity test, a cartesian similarity test, etc. The vector database can then retrieve the natural-language text strings represented by the identified vector embeddings and provide those text strings to server 100 for further use with method 300.

The vector database queried in step 308 can store vector representations of any relevant natural-language text information. For example, the vector database can store usable templates, forms, etc. that can be used by a language model during subsequent step 312. In yet further examples, the vector database can store vector representations of a user's chat history. The chat history can include, for example, one or more messages sent by the user as prompts and/or returned by server 100 as responses. Advantageously, providing portions of a user's chat history as context to a language model can increase the relevance of language model-generated response text. Further, querying a database storing vector embeddings of a user's chat history can allow for select portions of a user's chat history to be used to provide context during response generation (i.e., during subsequent step 312), reducing computational costs as compared to examples where a user's entire chat history is used as context for each prompt submitted by a user. Querying vector database 160 (step 308) retrieves non-vectorized (e.g. natural language) text corresponding to database vectors satisfying vector similarity criteria with query vectors, as discussed above.

In step 310, server 100 augments the natural-language prompt with data retrieved in step(s) 304 and the data retrieved in step 306. Server 100 can augment the natural-language prompt by adding natural-language representations of the information retrieved in step(s) 304 as well as the natural-language text string(s) retrieved in step 308 to the user prompt received in step 302.

In step 312, server 100 generates a natural-language response with a language model based on the augmented natural-language prompt generated in step 310. Server 100 provides the augmented natural-language prompt to a trained, computer-implemented machine-learning model configured to generate a natural-language text response based on a natural-language text prompt. The trained, computer-implemented machine-learning model can be referred to in some examples as a language model. In some examples the trained, computer-implemented machine-learning model can be a large language model and/or a transformer model.

In step 314, server 100 transmits the natural-language response text generated in step 312 to the user device. The chat client of the user device can represent an indication of the natural-language response text as a response to the user's prompt (i.e., the prompt received in step 302).

In step 316, the user device displays the natural-language response text to the user. Step 316 is optional and is performed where the chat client provides the initiation of the natural-language response by displaying, e.g., on a display device the natural-language text response. For example, local user device 140 can display the natural-language response text using user interface 146. As a further example, remote user device 190 can display the natural-language response text using user interface 196. The chat client operated by the user device can cause the user device to display the response text (e.g., by causing a processor of the device to execute one or more instructions that causes the user device to display the natural-language response text).

Method 300 advantageously uses a layered query approach to perform context injection (e.g., RAG) to enhance language model prompts and reduce the occurrence of hallucinations or fabrications in language model outputs. Method 300 provides the same advantages as described previously with respect to server 100 and layered query module 120 (FIG. 1). Notably, method 300 can be used to reduce computational cost associated with context injection approaches to hallucination and/or fabrication reduction (e.g., RAG), by using user-specific information (i.e., information retrieved in step(s) 304) to improve the relevance of information retrieved from a vector database (i.e., in step 308). As such, method 300 can be used to decrease the quantity of information (i.e., the quantity of text) provided to a language model for response generation by improving the likelihood that information used for context is user-relevant. Reducing the size of an input to a language model can decrease the computational load required to generate an output and, further, can thereby reduce the time required to produce the output. In examples where inputs to a language model are token-limited, method 300 can improve the likelihood that information included as context is relevant to a user's prompt. Further, as discussed previously with respect to server 100 and layered query module 120 (FIG. 1), method 300 can also be used to decrease computational cost associated with vector database queries.

Method 400 is a method of creating database vectors of a user's chat history. Method 400 can be used to, for example, generate database vectors for the database queried in step 308 of method 300 (FIG. 2), such as vector database 160 (FIG. 1). Method 400 includes steps 402-406 of receiving a user's chat history (step 402), separating the chat history into natural-language text segments (step 404), and vectorizing those natural-language text segments (step 406). Method 400 will be described herein with general reference to system 10 for explanatory purposes, however, method 400 can be performed by any suitable computing device.

In step 402, server 100 receives a user's chat history. Server 100 can store a user's chat history to, for example, memory 104 and server 100 can retrieve the user's chat history from memory 104 in step 402. Additionally and/or alternatively, the chat client used by the user can store the user's chat history, and server 100 can request the user's chat history from the user's chat client. The chat history includes all prompts submitted to by the user and/or all responses generated by server 100 in response to the chat history.

In step 404, server 100 separates the chat history into natural-language text segments. The segments can be sentences, paragraphs, individual messages (i.e., prompts and/or responses), and/or any other suitable size of text. The text segments are of a size (i.e., character length) that is suitable for vectorization in step 406.

In step 406, server 100 vectorizes the natural-language text segments generated in step 404. Server 100 can create vector embeddings of the natural-language text segments using any suitable embedding algorithm and having a number of dimensions. Server 100 can then store the text segments to a vector database, such as vector database 160.

### DISCUSSION OF POSSIBLE EMBODIMENTS

The following are non-exclusive descriptions of possible embodiments of the present invention.

A method comprising: receiving, by a processor of a network-connected device, a natural-language prompt from a user and a user identifier corresponding to the user; querying, by the processor, a first database with the user identifier to retrieve first information; generating, by the processor, a vector embedding representative of the first information and the natural-language prompt; querying, by the processor, a second database using the vector embedding to retrieve second information, wherein: the second database is a vector database comprising a plurality of vectors, each vector of the plurality of vectors representative of a text segment of a plurality of text segments, and the second information comprises at least one text segment of the plurality of text segments; and generating, by a language model executed by the processor, a natural-language response text responsive to the user query based on the natural-language prompt, the first information, and the second information.

The method of the preceding paragraph can optionally include, additionally and/or alternatively, any one or more of the following features, configurations and/or additional components:

A further embodiment of the foregoing method, wherein receiving, by the processor, the natural-language prompt and the user identifier comprises: receiving, by a chat client operated by a user device in electronic communication with the network-connected device, a natural-language text input from the user including the natural-language prompt; generating, by the user device, a request comprising the natural-language prompt and the user identifier; providing, by the user device, the request to the network-connected device; and extracting, by the processor, the user identifier and the natural-language prompt from the request.

A further embodiment of the foregoing method, wherein providing the request to the network-connected device comprises transmitting the request to the network-connected device via a communication network connecting the network-connected device and the user device.

A further embodiment of the foregoing method, and further comprising providing, by the chat client, an electronic indication of the natural-language response text to the user device.

A further embodiment of the foregoing method, and further comprising displaying, by a display of the user device, the natural-language response text to the user.

A further embodiment of the foregoing method, wherein the first database is at least one of a structured database and a semi-structured database.

A further embodiment of the foregoing method, and further comprising: receiving a chat history for the user, the chat user comprising a plurality of historical natural-language queries provided by the user and a plurality of historical natural-language response texts created by the language model; separating the plurality of natural-language queries and the plurality of historical natural-language response texts into a plurality of natural language text segments; vectorizing the plurality of natural language text segments to create the plurality of vectors.

A further embodiment of the foregoing method, wherein the first information describes a first attribute of the user.

A further embodiment of the foregoing method, wherein generating the natural-language response text comprises: generating an augmented natural-language prompt by combining text information from the natural-language prompt, the first information, and the second information; generating, by the language model, the natural-language response text based on the augmented natural-language prompt.

A further embodiment of the foregoing method, wherein querying the first database comprises: transmitting, by the network-connected device, a query request for the first database to a database server, wherein: the database server comprises the first database, and the request includes an application programming interface command for an application programming interface operated by the database server to query the first database; executing, by the application programming interface, the application programming interface command to query the first database to retrieve the first information; transmitting, by the database server, the retrieved first information to the network-connected device.

A further embodiment of the foregoing method, and further comprising querying, by the processor, a third database with the user identifier to retrieve third information, and wherein generating, by the processor, the vector embedding comprises a generating a vector embedding representative of the first information, the third information, and the natural-language prompt.

A further embodiment of the foregoing method, wherein: the first database is configured to store data according to a first database management system; and the third database is configured to store data according to a second database management system.

A further embodiment of the foregoing method, and further comprising querying, by the processor, a fourth database with the user identifier to retrieve fourth information, and wherein generating, by the processor, the vector embedding comprises a generating a vector embedding representative of the first information, the third information, the fourth information, and the natural-language prompt.

A further embodiment of the foregoing method, wherein: the first database is configured to store data according to a first database management system; the second database is configured to store data according to a second database management system; and the third database is configured to store data according to a third database management system.

A further embodiment of the foregoing method, wherein: the vector database comprises a plurality of partitions of vector data; querying the second database using the vector embedding comprises: selecting a partition of vector data of the plurality of partitions of vector data based on the user identifier; and comparing the vector embedding to vectors of the partition of vector data to retrieve the second information.

A system comprising: a first database configured to store first user-specific information; a second database configured to store a plurality of vector embeddings representative of a plurality of natural-language text segments, each vector embedding of the plurality of vector embeddings representative of one natural-language text segment of the plurality of natural-language text segments; a network-connected device in electronic communication with the first database and with the second database, the network-connected device comprising: a processor; and at least one memory encoded with instructions that, when executed, cause the processor to: receive a natural-language prompt from a user and a user identifier corresponding to the user; query the first database with the user identifier to retrieve first information; generate a vector embedding representative of the first information and the natural-language prompt; query the second database using the vector embedding to retrieve second information; and generate, using a language model executed by the processor, a natural-language response text responsive to the user query based on the natural-language prompt, the first information, and the second information.

The system of the preceding paragraph can optionally include, additionally and/or alternatively, any one or more of the following features, configurations and/or additional components:

A further embodiment of the foregoing system, wherein: the system further comprises a third database configured to store second user-specific information, the instructions, when executed, cause the processor to query the third database with the user identifier to retrieve third information, and the vector embedding is representative of the first information, the third information, and the natural-language prompt.

A further embodiment of the foregoing system, wherein the first information describes a first attribute of the user.

A further embodiment of the foregoing system, wherein the system further comprises a user device in electronic communication with the network-connected device, and the instructions, when executed, further cause the processor to transmit, to the user device, an electronic indication of the natural-language response text to the user device.

A further embodiment of the foregoing system, wherein the first database is at least one of a structured database and a semi-structured database.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
receiving, by a processor of a network-connected device, a natural-language prompt from a user and a user identifier corresponding to the user;
querying, by the processor, a first database with the user identifier to retrieve first information;
generating, by the processor, a vector embedding representative of the first information and the natural-language prompt;
querying, by the processor, a second database using the vector embedding to retrieve second information, wherein:
the second database is a vector database comprising a plurality of vectors,
each vector of the plurality of vectors representative of a text segment of a plurality of text segments, and
the second information comprises at least one text segment of the plurality of text segments; and
generating, by a language model executed by the processor, a natural-language response text responsive to the user query based on the natural-language prompt, the first information, and the second information.

2. The method of claim 1, wherein receiving, by the processor, the natural-language prompt and the user identifier comprises:
receiving, by a chat client operated by a user device in electronic communication with the network-connected device, a natural-language text input from the user including the natural-language prompt;
generating, by the user device, a request comprising the natural-language prompt and the user identifier;
providing, by the user device, the request to the network-connected device; and
extracting, by the processor, the user identifier and the natural-language prompt from the request.

3. The method of claim 2, wherein providing the request to the network-connected device comprises transmitting the request to the network-connected device via a communication network connecting the network-connected device and the user device.

4. The method of claim 2, and further comprising providing, by the chat client, an electronic indication of the natural-language response text to the user device.

5. The method of claim 4, and further comprising displaying, by a display of the user device, the natural-language response text to the user.

6. The method of claim 1, wherein the first database is at least one of a structured database and a semi-structured database.

7. The method of claim 1, and further comprising:
receiving a chat history for the user, the chat user comprising a plurality of historical natural-language queries provided by the user and a plurality of historical natural-language response texts created by the language model;
separating the plurality of natural-language queries and the plurality of historical natural-language response texts into a plurality of natural language text segments;
vectorizing the plurality of natural language text segments to create the plurality of vectors.

8. The method of claim 1, wherein the first information describes a first attribute of the user.

9. The method of claim 1, wherein generating the natural-language response text comprises:
generating an augmented natural-language prompt by combining text information from the natural-language prompt, the first information, and the second information;
generating, by the language model, the natural-language response text based on the augmented natural-language prompt.

10. The method of claim 1, wherein querying the first database comprises:
transmitting, by the network-connected device, a query request for the first database to a database server, wherein:
the database server comprises the first database, and
the request includes an application programming interface command for an application programming interface operated by the database server to query the first database;
executing, by the application programming interface, the application programming interface command to query the first database to retrieve the first information;
transmitting, by the database server, the retrieved first information to the network-connected device.

11. The method of claim 1, and further comprising querying, by the processor, a third database with the user identifier to retrieve third information, and wherein generating, by the processor, the vector embedding comprises a generating a vector embedding representative of the first information, the third information, and the natural-language prompt.

12. The method of claim 11, wherein:
the first database is configured to store data according to a first database management system; and
the third database is configured to store data according to a second database management system.

13. The method of claim 11, and further comprising querying, by the processor, a fourth database with the user identifier to retrieve fourth information, and wherein generating, by the processor, the vector embedding comprises a generating a vector embedding representative of the first information, the third information, the fourth information, and the natural-language prompt.

14. The method of claim 13, wherein:
the first database is configured to store data according to a first database management system;
the second database is configured to store data according to a second database management system; and
the third database is configured to store data according to a third database management system.

15. The method of claim 1, wherein:
the vector database comprises a plurality of partitions of vector data;
querying the second database using the vector embedding comprises:
selecting a partition of vector data of the plurality of partitions of vector data based on the user identifier; and
comparing the vector embedding to vectors of the partition of vector data to retrieve the second information.

16. A system comprising:
a first database configured to store first user-specific information;
a second database configured to store a plurality of vector embeddings representative of a plurality of natural-language text segments, each vector embedding of the plurality of vector embeddings representative of one natural-language text segment of the plurality of natural-language text segments;
a network-connected device in electronic communication with the first database and with the second database, the network-connected device comprising:
a processor; and
at least one memory encoded with instructions that, when executed, cause the processor to:
receive a natural-language prompt from a user and a user identifier corresponding to the user;
query the first database with the user identifier to retrieve first information;
generate a vector embedding representative of the first information and the natural-language prompt;
query the second database using the vector embedding to retrieve second information; and
generate, using a language model executed by the processor, a natural-language response text responsive to the user query based on the natural-language prompt, the first information, and the second information.

17. The system of claim 16 wherein:
the system further comprises a third database configured to store second user-specific information,
the instructions, when executed, cause the processor to query the third database with the user identifier to retrieve third information, and
the vector embedding is representative of the first information, the third information, and the natural-language prompt.

18. The system of claim 16, wherein the first information describes a first attribute of the user.

19. The system of claim 16, wherein the system further comprises a user device in electronic communication with the network-connected device, and the instructions, when executed, further cause the processor to transmit, to the user device, an electronic indication of the natural-language response text to the user device.

20. The system of claim 16, wherein the first database is at least one of a structured database and a semi-structured database.
